(19) United States
(12) Patent Application Publication
(10) Pub. No.: US 2019/0162979 A1
(43) Pub. Date: May 30, 2019

(54) CLOSURE DEVICES AND CONTAINER SYSTEMS

(71) Applicant: NEWTONOID TECHNOLOGIES, L.L.C., LIBERTY, MO (US)

(72) Inventors: FIELDING B. STATON, LIBERTY, MO (US); DAVID STRUMPF, COLUMBIA, MO (US)

(21) Appl. No.: 16/246,145

(22) Filed: Jan. 11, 2019

Related U.S. Application Data
(63) Continuation-in-part of application No. 16/162,973, filed on Oct. 17, 2018.
Application No. 16/162,973 is a continuation of application No. 15/677,824, filed on Aug. 15, 2017, now Pat. No. 10,139,641.
(60) Provisional application No. 62/616,195, filed on Jan. 11, 2018.

(51) Int. Cl. G02B 27/22; G09F 19/12; G09F 13/02; G09F 13/14; B65D 51/24; B65D 5/42; G06K 19/077; B65D 5/00; B65D 25/54; G09F 23/00

(52) U.S. Cl. CPC G02B 27/2292; G09F 19/12; G09F 13/02; G09F 13/14; B65D 51/248; G09F 23/00; B65D 51/245; G06K 19/07749; B65D 5/008; B65D 25/54; B65D 5/4212

(57) ABSTRACT

A container system includes a first container for holding first contents; a resonant surface disposed on or within the container; and an excitation device for providing an excitation to the resonant surface. Excitation of the resonant surface provides a resonant response, which defines information about a property of the container.

### CROSS-REFERENCE TO RELATED APPLICATIONS

This application claims priority to U.S. Provisional Patent Application No. 62/616,195, filed Jan. 11, 2018. This application is also a continuation-in-part of U.S. patent application Ser. No. 16/162,973, filed Oct. 17, 2018, which is a continuation of U.S. patent application Ser. No. 15/677,824, filed Aug. 15, 2017. Each of these referenced applications are incorporated herein by reference in their entireties.

### BACKGROUND

Embodiments of the current invention relate generally to container systems and closure devices for use with containers. The inventive containers include, but are not limited to, bottles, pitchers, drinking glasses, jugs, snow globes, fish tanks, shelving, display housings, and electronics enclosures.

### SUMMARY

The following presents a simplified summary of the invention in order to provide a basic understanding of some aspects of the invention. This summary is not an extensive overview of the invention. It is not intended to identify critical elements of the invention or to delineate the scope of the invention. Its sole purpose is to present some concepts of the invention in a simplified form as a prelude to the more detailed description that is presented elsewhere.

According to one embodiment, a container system includes a transparent display, a projector for providing image data on the display, and a floor defining part of a watertight cavity. The display is non-perpendicularly angled from horizontal and has proximal and distal ends.

According to another embodiment, a closure device is provided for use with a watertight container. The closure device is configured to selectively seal an opening in the watertight container and includes coupling structure (a plug, a flange, and/or threading) for selectively coupling the closure device to the watertight container to seal the opening. The closure device further includes non-transitory computer memory, at least one sensor, and a processor in data communication with the memory and the at least one sensor.

According to still another embodiment, a container system includes a first container for holding first contents; a resonant surface disposed on or within the container; and an excitation device for providing an excitation to the resonant surface. Excitation of the resonant surface provides a resonant response, which defines information about a property of the container.

According to still yet another embodiment, a container system includes a container for holding contents; a reflective surface disposed on or within the container; and an excitation device for providing an excitation to the reflective surface. Excitation of the reflective surface provides a resonant response, which defines information about the properties of the container and the contents therein.

According to a further embodiment, a container system includes a container for holding contents, the container having a resonant surface disposed on or within the container, and a computing system comprising an excitation device for providing an excitation to the resonant surface and a sensor for measuring a resonant response of the resonant surface in response to the excitation, the resonant response defining an attribute of the container. The computing system further includes a processor in data communication with a networking device, at least one input/output device, and computer memory, the computer memory comprising a program having machine readable instructions that, when effected by the processor, perform the following steps: (a) generating an excitation via the excitation device; (b) determining, via the sensor, a baseline resonant response of the resonant surface; (c) storing the baseline resonant response in computer memory; (d) generating a second excitation via the excitation device; (e) determining, via the sensor, a second resonant response of the resonant surface; (f) comparing the second resonant response with the baseline resonant response; and (g) activating an alert if the second resonant response is outside of a predetermined threshold, the predetermined threshold being based on the baseline resonant response.

### BRIEF DESCRIPTION OF THE DRAWINGS

FIG. 1 is a perspective view of a container system according to an embodiment of the current invention.

FIG. 2 is a front view of the container system of FIG. 1.

FIG. 3 is an exploded view of the container system of FIG. 1.

FIG. 4 is a section view taken from FIG. 1, with some features illustrated schematically.

FIG. 5 is a front view of the display of the container system of FIG. 1.

FIG. 6 is an end view of the display of the container system of FIG. 1.

FIG. 7 is a block diagram illustrating aspects of the container system of FIG. 1.

FIG. 8 is a flowchart illustrating various steps performed by the container system of FIG. 1.

FIG. 9a is a front view of a container system according to another embodiment of the current invention.

FIG. 9b is a section view taken from FIG. 9a, with some features illustrated schematically.

FIG. 10 is a front view of a container system according to still another embodiment of the current invention.

FIG. 11 is a perspective view of a container system according to yet another embodiment of the current invention.

FIG. 12 is a perspective view of an alternate closure device for use with various embodiments of the current invention, with some features illustrated schematically.

FIG. 13 is a front view of a container system according to still yet another embodiment of the current invention, with some features illustrated schematically.

FIG. 14 is a perspective view of a container system according to a further embodiment of the current invention.

FIG. 15 is a section view of a container system according to a further embodiment of the current invention.

FIG. 16 is a perspective view of a container system according to still another embodiment of the current invention.

FIG. 17 is an exemplary graphical user interface according to a further embodiment of the invention.

FIG. 18 is a perspective view of a container system according to still yet another embodiment of the invention.

### DETAILED DESCRIPTION

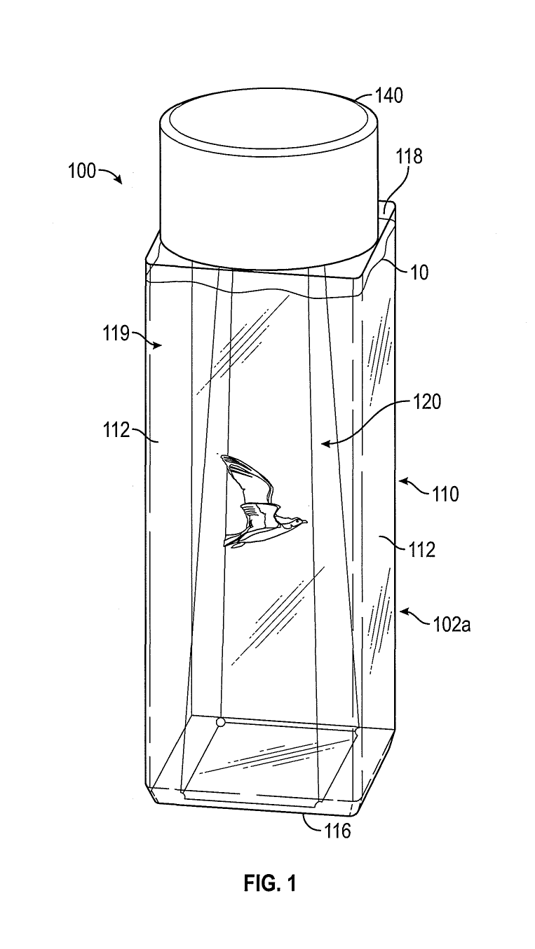

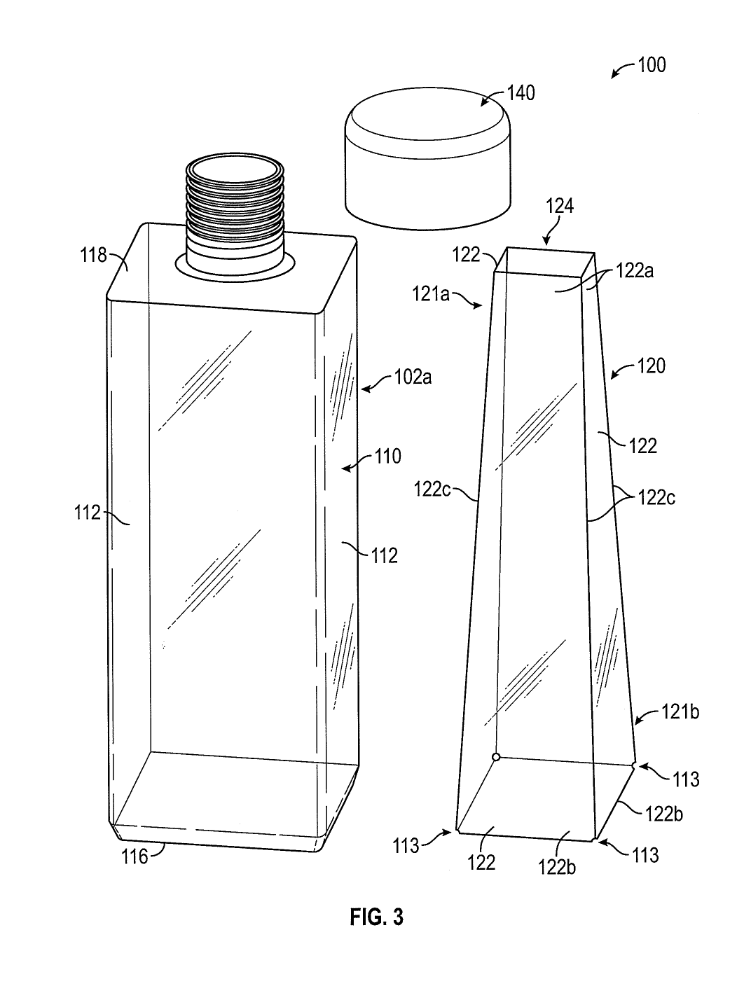

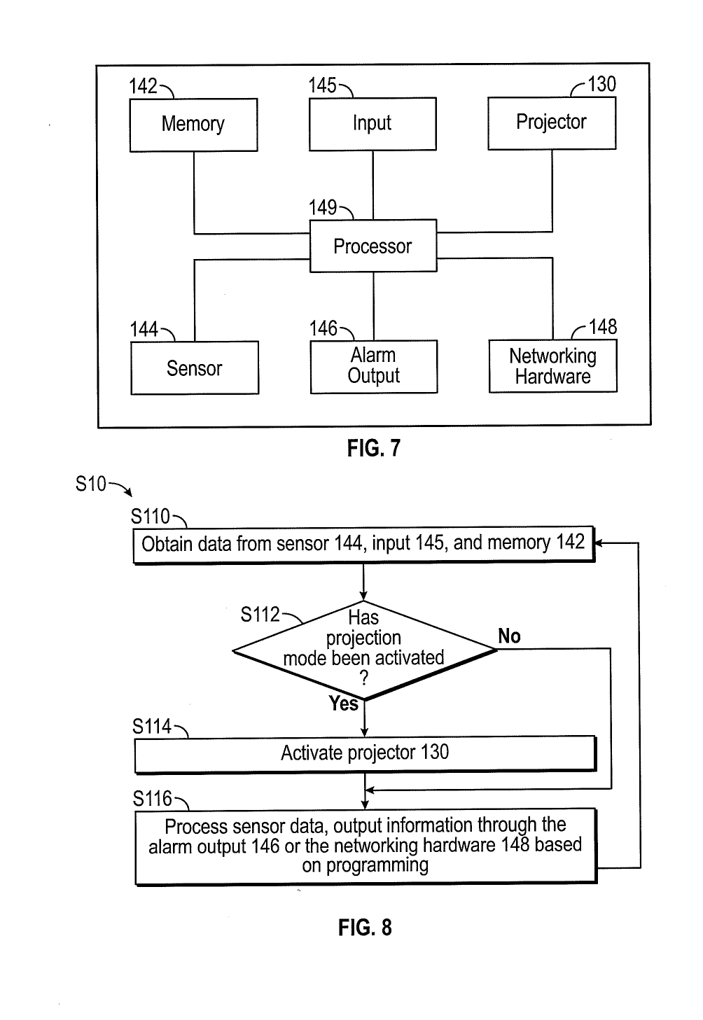

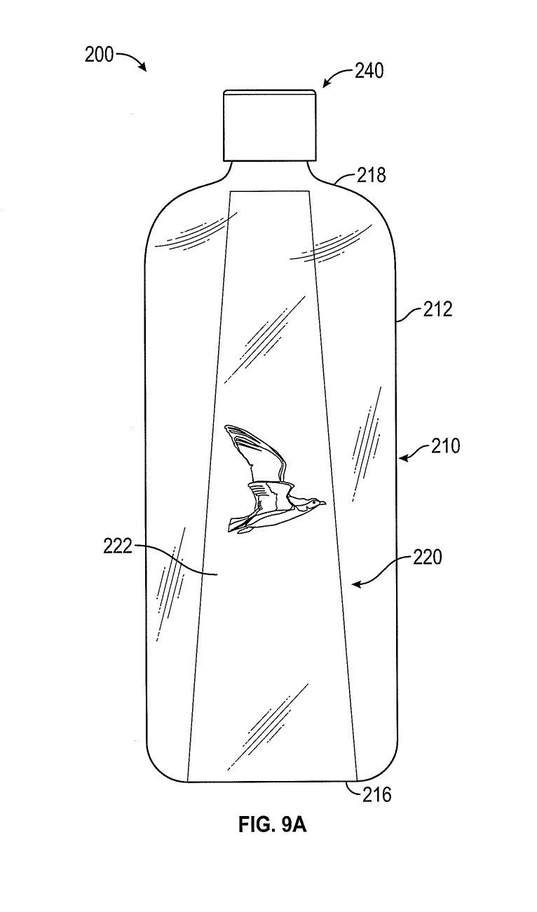

FIGS. 1 through 8 illustrate a container system, according to an embodiment 100 of the current invention. The container system 100 includes an exterior perimeter 110, a floor 116, a top end 118, a transparent display 120 non-perpendicularly angled from horizontal, and a projector 130 for providing image data on the display 120.

The exterior perimeter 110 is defined by at least one external wall 112 extending upwardly from the floor 116. And the floor 116, the top end 118, and the exterior perimeter 110 each form part of a watertight cavity 119. “Watertight” is used herein to mean capable of retaining water or other liquid, gas, or solid particles 10. In some embodiments, including the embodiment 100, the watertight cavity 119 may further be spill-proof (i.e., resistant to losing contents even if turned upside down). For example, as shown in FIGS. 1 through 4, a closure device 140 may be configured to selectively seal an opening 118a in the top end 118. The external walls 112 may be constructed of glass, acrylic, polycarbonate, transparent aluminum, or any other appropriate material, and may be formed through extrusion, blowing, additive manufacturing, or any other appropriate processes. FIGS. 1 through 4 show that the exterior perimeter 110 and the floor 116 may define at least part of a bottle 102a. In other embodiments, the exterior perimeter 110 and the floor 116 may define at least part of another type of container—such as a bottle, pitcher, drinking glass, jug, snow globe, fish tank, shelf, display housing, or an electronics enclosure.

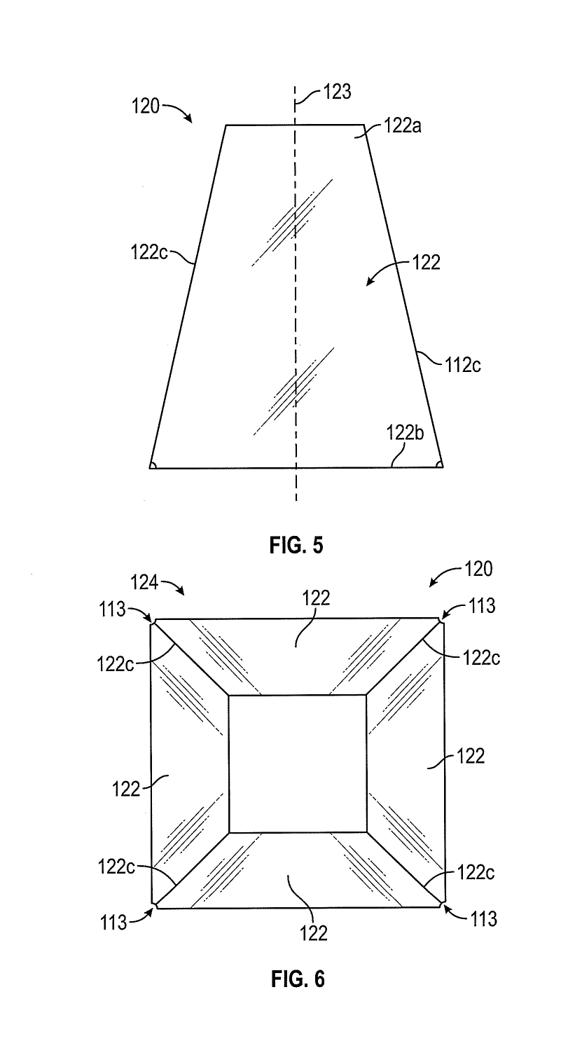

The display 120 is inside the exterior perimeter 110, has proximal and distal ends 121a, 121b, and includes a plurality of (e.g., four) transparent panels 122. Each panel 122 has a proximal end 122a, a distal end 122b larger than the proximal end 122a, and opposed sides 122c. The panel proximal ends 122a correspond to the display proximal end 121a, and the panel distal ends 122b correspond to the display distal end 121b. Each panel side 122c is adjacent one of the sides 122c of another panel 122, such that a ring 124 is formed. It may be particularly desirable for the ring 124 to be centered along a center axis 124a. In the embodiment 100, the display distal end 121b is generally adjacent the floor 116, and the display proximal end 121a is generally adjacent the top end 118; said differently, the display distal end 121b is closer to the floor 116 than is the display proximal end 121a. As shown in FIG. 5, it may be desirable for each panel 122 to be generally symmetrical about a center line 123. And it may be desirable for each panel 122 to be generally planar.

The display 120 may be constructed of glass, polycarbonate, transparent aluminum, or any other appropriate material. In some embodiments, the display 120 may be formed simultaneously with the exterior perimeter 110. In other embodiments, the display 120 may be inserted inside the exterior perimeter 110 before the floor 116 or the top end 118 is attached. And in still other embodiments, the display 120 may be inserted inside the exterior perimeter 110 through the opening 118a in the top end 118. Particularly if being inserted through the opening 118a, the ring 124 formed by the display 120 may be foldable for insertion through the top end opening 118a and a biasing member (e.g., a resilient wire) may be coupled to at least one of the panels 122 to bias the ring 124 to the unfolded configuration. As such, the folded ring 124 may be inserted through the opening 118a and the biasing member may thereafter cause the ring 124 to unfold inside the exterior perimeter 110. Especially if the ring 124 is folded, it may be desirable for the panels 122 to be constructed of pliable material.

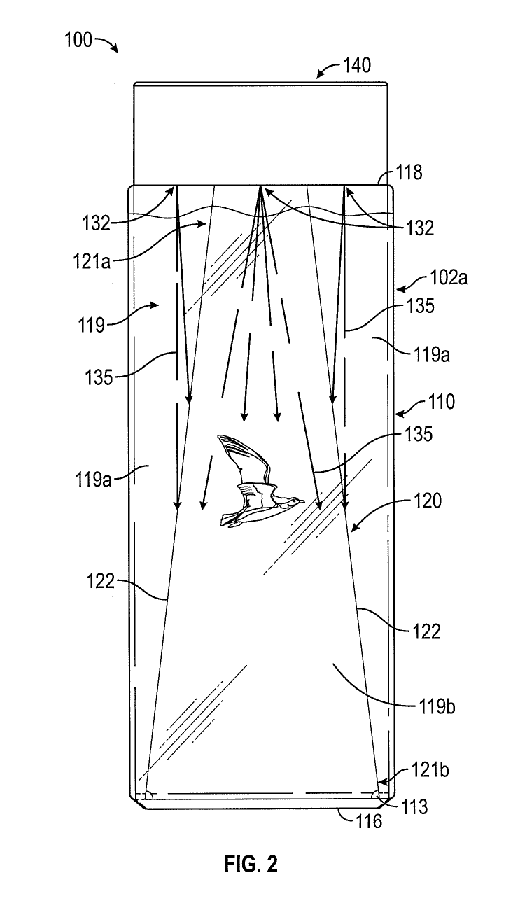

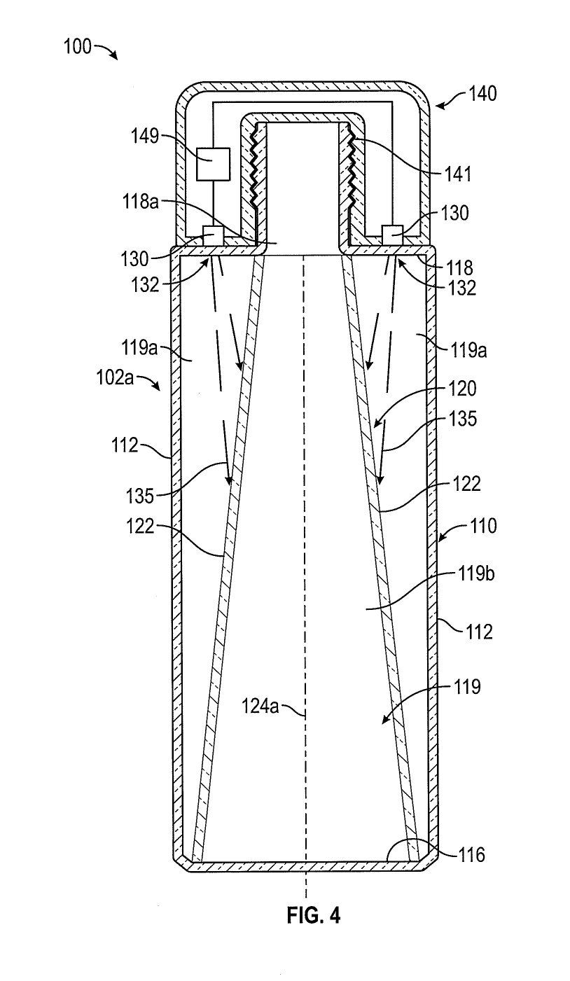

As shown in FIGS. 2 and 4, an outer portion 119a of the watertight cavity 119 extends outwardly from the panels 122 to the external walls 112, an inner portion 119b of the cavity 119 extends inwardly from the panels 122, and at least one passage 113 allows fluid 10 to freely flow between the outer and inner portions 119a, 119b of the watertight cavity 119. In other embodiments, the outer portion 119a and the inner portion 119b may not be in fluid communication with one another, such that different substances may be housed in the portions 119a, 119b; or either portion 119a, 119b may be incapable of housing a substance (e.g., by being sealed or non-hollow). As such, the transparent panels 122 may form at least part of the watertight cavity 119, with an area between the external walls 112 and the panels 122 being devoid of the fluid.

Turning now to the closure device 140, the closure device 140 has coupling structure 141 (e.g., a plug, a flange, and/or threading) for selectively coupling the closure device 140 to the top end 118 to seal the opening 118a, and alignment indicators such as indicia or click tabs may be used to position the closure device 140 at a particular angle about the axis 124a. In addition, the closure device 140 of embodiment 100 contains the projector 130, non-transitory computer memory 142, at least one sensor 144, an input device 145, an alarm output 146, networking hardware 148, and a processor 149 (although it shall be understood that one or more components (e.g., the computer memory, processor, etc.) may be located separate from the closure device 140. The projector 130 may have a single lens output, may have multiple lenses, or zero lens (e.g. transmission junction element with no separate lens) to output images. If a single lens is used, it may be desirable for the lens to have multiple image origination areas, preferably with one image origination area 132 for each panel 122; if multiple lenses are used, it may be preferable for each lens to be configured to transmit images to a respective one of the panels 122 (so, for example, four lenses may be used in embodiments having four panels 122). With multiple lenses, each lens may be considered a respective image origination area 132. Each lens may be used to focus onto a fixed focal length or provide a more complex progressive lens design that allows projection onto multiple variable surfaces with differing focal lengths (e.g., non-planar display surfaces).

The computer memory 142 may include volatile and non-volatile memory, and any appropriate data storage devices whether now existing or later developed may be used. The computer memory and logical processing elements are not limited to currently available silicon electronic technologies and may consist of optical or smart material particles (e.g., graphene or carbon nanotubes). Further, the computer memory 142 may be a unitary memory in one location, or may alternately be a distributed computer memory such that one portion of the computer memory is physically separate from another portion of the non-transitory computer memory. In other words, discrete computer memory devices may be linked together (e.g., over a network) and collectively form the computer memory 142. While this document shall often refer to elements in the singular, those skilled in the art will appreciate that multiple such elements may often be employed and that the use of multiple such elements which collectively perform as expressly or inherently disclosed is fully contemplated herein. Computer memory 142 may consist of any combination of machine readable and human readable elements (e.g. printed imagery that is static or dynamic in memory element attribute storage functionality).

The at least one sensor 144 may be, for example, at least one sensor for providing data about at least one quality characteristic (e.g., acidity, temperature, pressure, chemical, sugar, alcohol, bacteria, biohazard, radioactive, etc.) of a fluid housed in the watertight cavity 119, at least one sensor for providing data about the quantity of the fluid housed in the watertight cavity 119, and/or at least one sensor for providing data about whether the closure device 140 is sealing the opening 118a in the top end 118. The input device 145 may be a button, switch, sensing film, or other appropriate device allowing a user to provide data to the processor 149. The alarm output 146 may be, for example, an audible (e.g. sound, haptic, vibration) or visual alarm indicating that an alarm condition is present or has occurred. The networking hardware 148 may be any appropriate hardware (whether now existing or later developed) allowing the processor 149 to communicate with other electronic devices. Example networking hardware 148 includes ports, transmitters, receivers, and transceivers.

The processor 149 may be any appropriate device, whether now existing or later developed, which performs the operations specified by the various programming used. The processor 149 may be electronic circuitry located on an integrated circuit component, printed circuit board assembly, or may be a distributed processor such that one portion of the processor is physically separate from another portion of the processor. The processor 149 is in data communication with the projector 130, the computer memory 142, the at least one sensor 144, the alarm output 146, and the networking hardware 148.

The following description is an example of the container system 100 in use according to an embodiment. At step S100 of method S10, the processor 149 obtains data from the memory 142, the at least one sensor 144, and the input device 145. After step S100, the method S10 proceeds to step S112. At step S112, the processor 149 determines if the projector 130 should be actuated. This determination may be based, for example, on the data obtained in step S110 (e.g., whether the closure device 140 is sealing the opening 118a, whether an amount of time stored in the memory 142 has been exhausted, et cetera). Yet in other embodiments, the projector 130 may be activated automatically upon the projector 130 being powered. Those skilled in the art will appreciate that the various electronic components may be powered by batteries, fuel-cells, solar cells, and power-generating or harvesting devices—whether now existing or later developed—and that one or more switches may be provided to selectively power the components. In some embodiments, the processor 149 may additionally select image data (e.g., from the memory 142) at step 142 for providing to the projector 130, again based on the data obtained in step S110. If the processor 149 determines that the projector 130 should be activated, the method S10 proceeds to step S114; if not, the method S10 continues to step S116. At step S114, the processor 149 activates the projector 130, either with the only image data available or using image data selected in step S112. “Image data” as used herein encompasses both static and sequential (or what appears to be “moving”) image data. The travel path 135 of images from the image origination areas 132 to the display 120 in the embodiment 100 is illustrated in FIGS. 2 and 4. The method S10 then moves to step S116. At step S116, the processor 149 processes data from the at least one sensor 144 (obtained at step S110) and outputs information through the alarm output 146 and/or the networking hardware 148 based on programming in the memory 142. For example, if the processor 149 determines that the acidity, temperature, or pressure of the fluid 10 is outside predetermined ranges, that the amount of fluid 10 is low, or that the top end 118a is not properly sealed, the alarm output 146 may be activated and/or a warning may be sent to another electronic device through the networking hardware 148. The method then returns from step S116 to step S110.

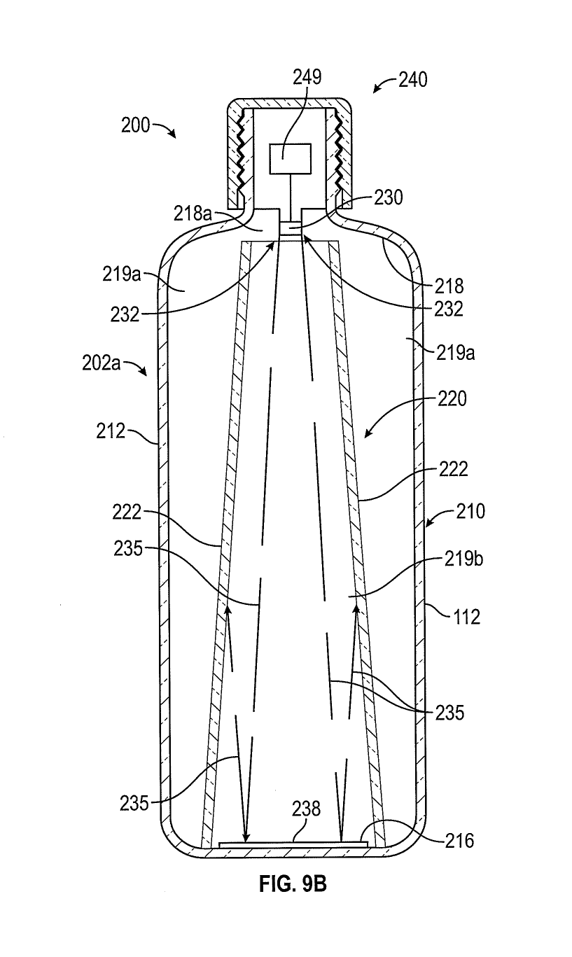

FIGS. 9a and 9b illustrate another container system 200 that is substantially similar to the embodiment 100, except as specifically noted and/or shown, or as would be inherent. Further, those skilled in the art will appreciate that the embodiment 100 (and thus the embodiment 200) may be modified in various ways, such as through incorporating all or part of any of the various described embodiments, for example. For uniformity and brevity, reference numbers from 200 to 299 may be used to indicate elements corresponding to those discussed above numbered from 100 to 199 (e.g., exterior perimeter 210 corresponds generally to the exterior perimeter 110, external wall 212 corresponds generally to the external walls 112, floor 216 corresponds generally to the floor 116, top end 218 corresponds generally to the top end 118, opening 218a corresponds generally to the opening 118a, outer and inner portions 219a, 219b correspond generally to the outer and inner portions 119a, 119b, transparent display 220 corresponds generally to the transparent display 120, panels 222 correspond generally to the panels 122, projector 230 corresponds generally to the projector 130, closure device 240 corresponds generally to the closure device 140, processor 249 corresponds generally to the processor 149, et cetera), though with any noted, shown, or inherent deviations.

In embodiment 200, one difference from the embodiment 100 is that the embodiment 100 has four external walls 112 defining the external perimeter 110, while the embodiment 200 has one continuous (circular) wall 212 defining the external perimeter 210. Further, the image origination areas 132 are located radially outside the display proximal end 121a, while the image origination areas 232 are radially inside the display proximal end 221a. A reflective surface (mirror) 238 is adjacent or formed by the floor 216, and the image travel path 235 extends from the image origination areas 232 to the reflective surface 238 and then to the display 220.

Also, the display 120 extends to the top end 118, while the display 220 stops short of the top end 218. As such, in the embodiment 200, fluid may pass between the outer and inner portions 219a, 219b by going over the display 220. In other words, a passage over the display 220 may allow fluid to freely flow between the outer and inner portions 219a, 219b.

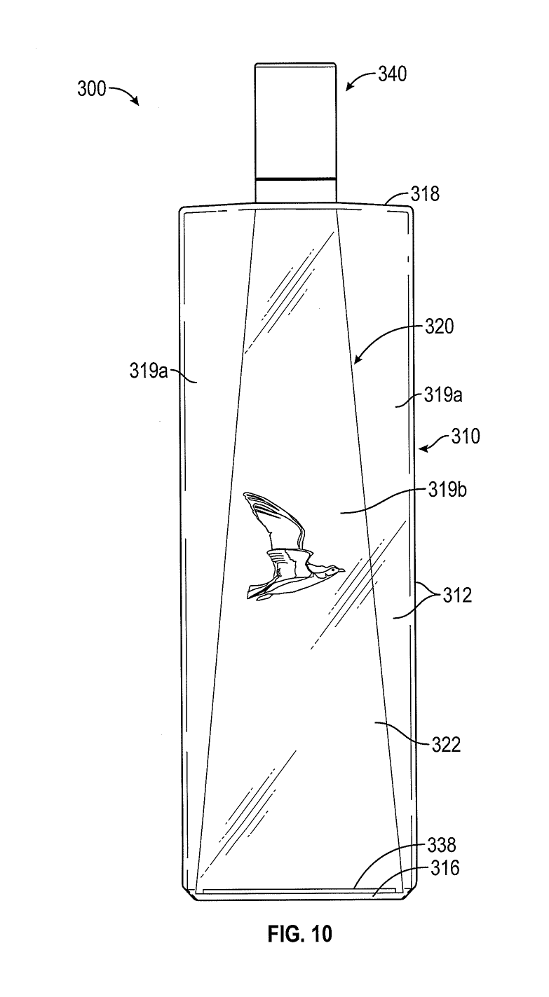

FIG. 10 illustrates another container system 300 that is substantially similar to the embodiment 200, except as specifically noted and/or shown, or as would be inherent. Further, those skilled in the art will appreciate that the embodiment 200 (and thus the embodiment 300) may be modified in various ways, such as through incorporating all or part of any of the various described embodiments, for example. For uniformity and brevity, reference numbers from 300 to 399 may be used to indicate elements corresponding to those discussed above numbered from 200 to 299 (e.g., exterior perimeter 310 corresponds generally to the exterior perimeter 210, external wall 312 corresponds generally to the external walls 212, floor 316 corresponds generally to the floor 216, top end 318 corresponds generally to the top end 218, outer and inner portions 319a, 319b correspond generally to the outer and inner portions 219a, 219b, transparent display 320 corresponds generally to the transparent display 220, panels 322 correspond generally to the panels 222, reflective surface 338 corresponds generally to the reflective surface 238, closure device 340 corresponds generally to the closure device 240, et cetera), though with any noted, shown, or inherent deviations.

In embodiment 300, the primary difference from the embodiment 100 is that the embodiment 300 has four external walls 312 defining the exterior perimeter 310 (similar to the walls 112 defining the exterior perimeter 110), instead of the single circular wall 212. And, instead of the display 320 stopping short of the top end 318, the display 320 extends to the top end 218 (similar to the embodiment 100).

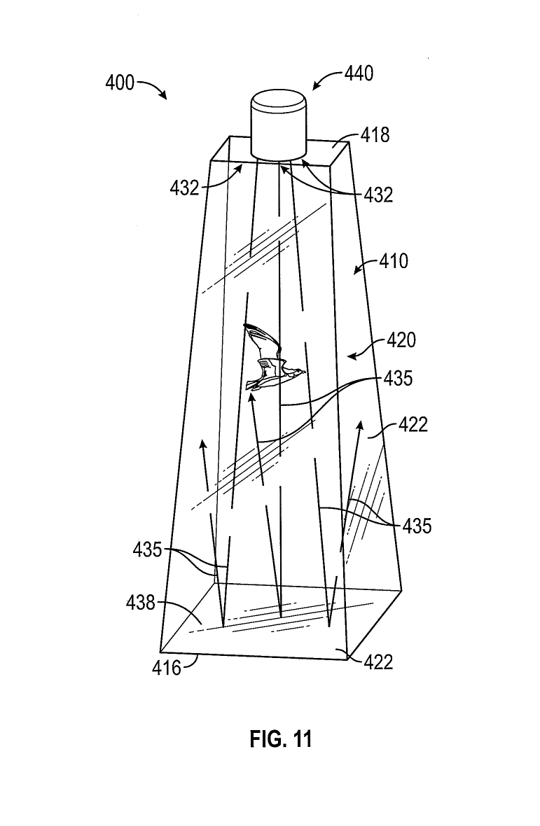

FIG. 11 illustrates another container system 400 that is substantially similar to the embodiment 100, except as specifically noted and/or shown, or as would be inherent. Further, those skilled in the art will appreciate that the embodiment 100 (and thus the embodiment 400) may be modified in various ways, such as through incorporating all or part of any of the various described embodiments, for example. For uniformity and brevity, reference numbers from 400 to 499 may be used to indicate elements corresponding to those discussed above numbered from 100 to 199 (e.g., exterior perimeter 410 corresponds generally to the exterior perimeter 110, floor 416 corresponds generally to the floor 116, top end 418 corresponds generally to the top end 118, transparent display 420 corresponds generally to the transparent display 120, panels 422 correspond generally to the panels 122, image origination areas 432 correspond generally to the image origination areas 132, closure device 440 corresponds generally to the closure device 140, et cetera), though with any noted, shown, or inherent deviations.

In embodiment 400, one difference from the embodiment 100 is that the exterior perimeter 410 in the embodiment 400 is defined by the display 420 (i.e., the panels 422) instead of being defined by separate external walls (corresponding to the external walls 112). Or, viewed differently, the panels 422 function as both the panels 122 and the walls 112. Further, the positioning of the image origination areas 432 and travel paths 435 are generally as set out in the embodiment 200 (including use of a reflective surface 438 corresponding generally to the reflective surface 238).

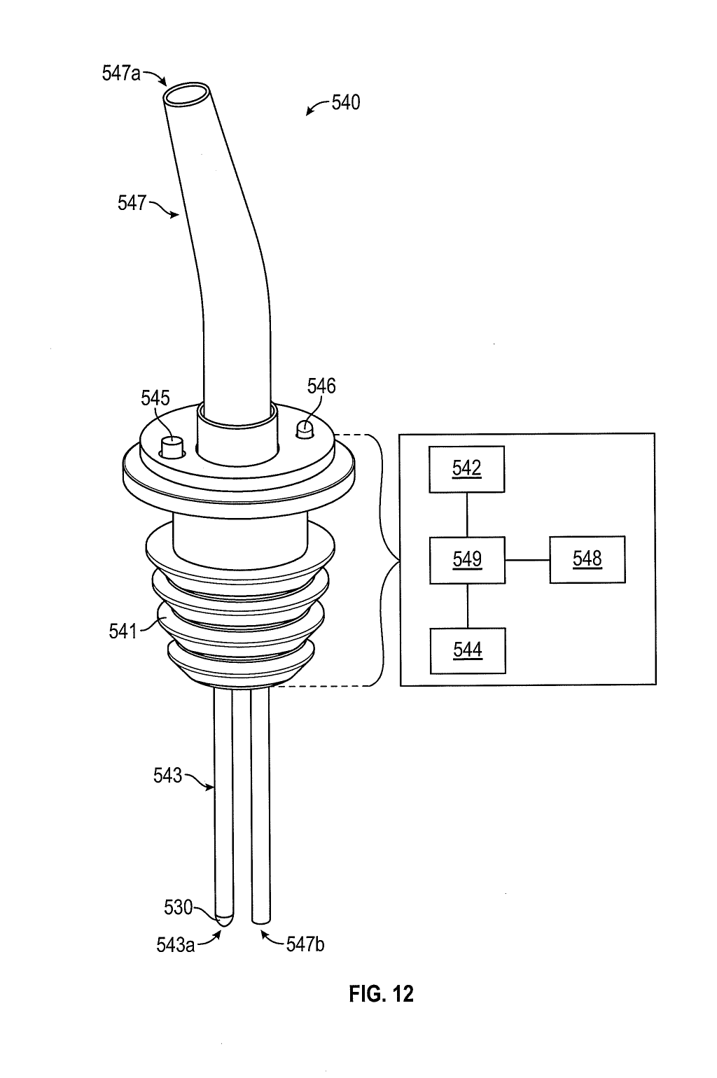

FIG. 12 illustrates another closure device 540 that may be used in embodiments of the current invention. For uniformity and brevity, reference numbers from 500 to 599 may be used to indicate elements corresponding to those discussed above numbered from 100 to 199 (e.g., coupling structure 541 corresponds generally to coupling structure 141, projector 530 corresponds generally to the projector 130, computer memory 542 corresponds generally to the computer memory 142, at least one sensor 544 corresponds generally to the at least one sensor 144, an input device 545 corresponds generally to the input device 145, an alarm output 546 corresponds generally to the alarm output 146, networking hardware 548 corresponds generally to the networking hardware 148, processor 549 corresponds generally to the processor 149, et cetera), though with any noted, shown, or inherent deviations.

The closure device 540 differs from the illustrated closure device 140 in a few main ways. First, the coupling structure 541 includes a plug, whereas the coupling structure 141 includes threading. Second, the projector 530 is positioned at an end 543a of a rod 543, allowing the projector 530 to extend further into the cavity 119 (and closer to the display 120). And third, the closure device 540 includes a pout spout 547 allowing fluid to be poured from the cavity 119. The pour spout 547 has upper and lower ends 547a, 547b and a passageway therebetween. In some embodiments, it may be desirable to have a valve between the ends 547a, 547b to restrict flow. In the embodiment 540, the projector 530 is located generally adjacent the lower end 547b of the pour spout 547.

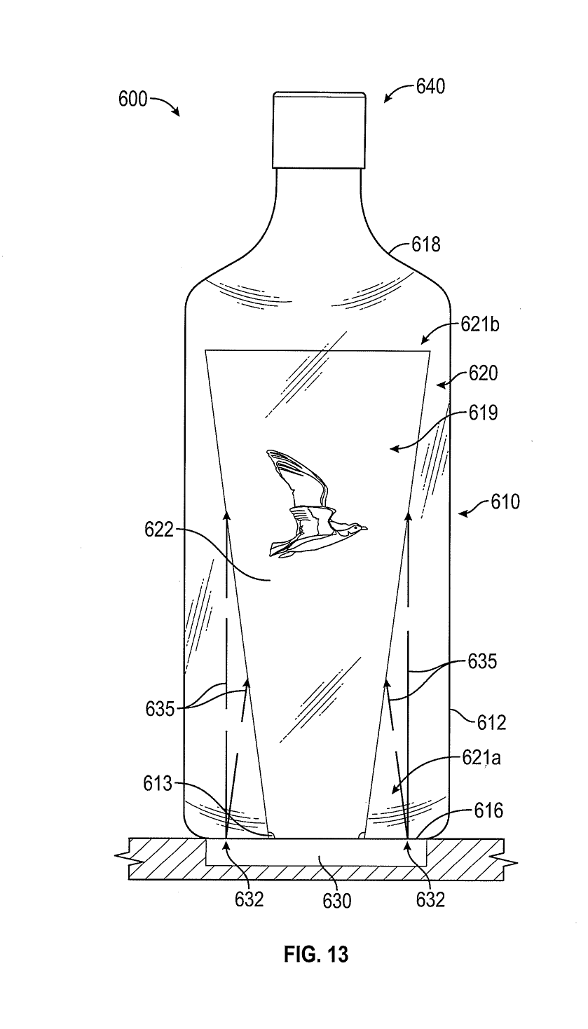

FIG. 13 illustrates another container system 600 that is substantially similar to the embodiment 100, except as specifically noted and/or shown, or as would be inherent. Further, those skilled in the art will appreciate that the embodiment 100 (and thus the embodiment 600) may be modified in various ways, such as through incorporating all or part of any of the various described embodiments, for example. For uniformity and brevity, reference numbers from 600 to 699 may be used to indicate elements corresponding to those discussed above numbered from 100 to 199 (e.g., exterior perimeter 610 corresponds generally to the exterior perimeter 110, external wall 612 corresponds generally to the external walls 112, passages 613 correspond generally to the passages 113, floor 616 corresponds generally to the floor 116, top end 618 corresponds generally to the top end 118, watertight cavity 619 corresponds generally to the watertight cavity 119, transparent display 620 corresponds generally to the transparent display 120, panels 622 correspond generally to the panels 122, image origination areas 632 correspond generally to the image origination areas 132, closure device 640 corresponds generally to the closure device 140, et cetera), though with any noted, shown, or inherent deviations.

In embodiment 600, there are two primary differences from the embodiment 100: the display proximal end 621a is closer to the floor 616 than is the display distal end 621b, and the projector 630 is relocated to still provide the image data to the proximal end 621a before providing the image data to the distal end 621b. In FIG. 13, the projector 630 is positioned to provide the image data generally upwardly, and the floor 616 is selectively positionable atop the projector 630 such that the image data is provided on the display 620 (via image travel paths 635) only when the floor 616 is positioned atop the projector 630. The projector 630 may be housed in a coaster, a bar surface, or another device, and some embodiments may include a housing below the floor 616 to house the projector 630 and allow the projector 630 to be fixed relative to the display 620.

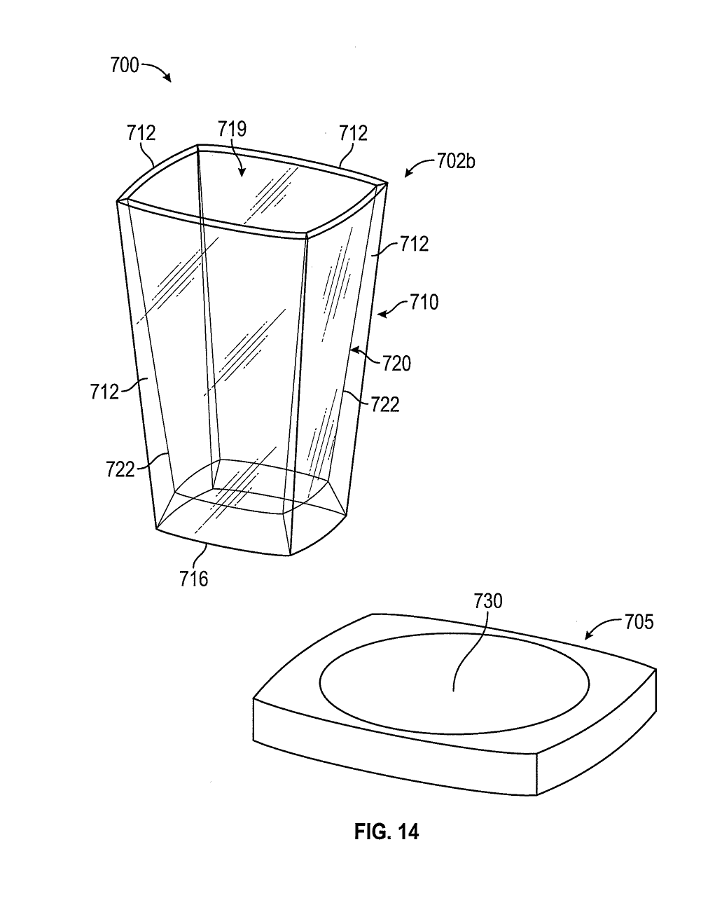

FIG. 14 illustrates another container system 700 that is substantially similar to the embodiment 600, except as specifically noted and/or shown, or as would be inherent. Further, those skilled in the art will appreciate that the embodiment 600 (and thus the embodiment 700) may be modified in various ways, such as through incorporating all or part of any of the various described embodiments, for example. For uniformity and brevity, reference numbers from 700 to 799 may be used to indicate elements corresponding to those discussed above numbered from 600 to 699 (e.g., exterior perimeter 710 corresponds generally to the exterior perimeter 610, external wall 712 corresponds generally to the external walls 612, floor 716 corresponds generally to the floor 616, watertight cavity 719 corresponds generally to the watertight cavity 619, transparent display 720 corresponds generally to the transparent display 620, panels 722 correspond generally to the panels 622, et cetera), though with any noted, shown, or inherent deviations.

Embodiment 700 does not have a top end corresponding to the top end 618; instead, the watertight cavity 719 is simply open upwardly as the exterior perimeter 710 and the floor 716 define a drinking glass 702b. In addition, embodiment 700 does not have passages corresponding to passages 613 and liquid does not pass between the panels 722 and the external walls 712. And the projector 730 is illustrated as part of a coaster 705. The cup 702b is shown separated from the coaster 705 for illustration, and the cup 102b is positionable atop the coaster 705 such that image data is provided on the display 720 when the floor 716 is positioned atop the projector 730.

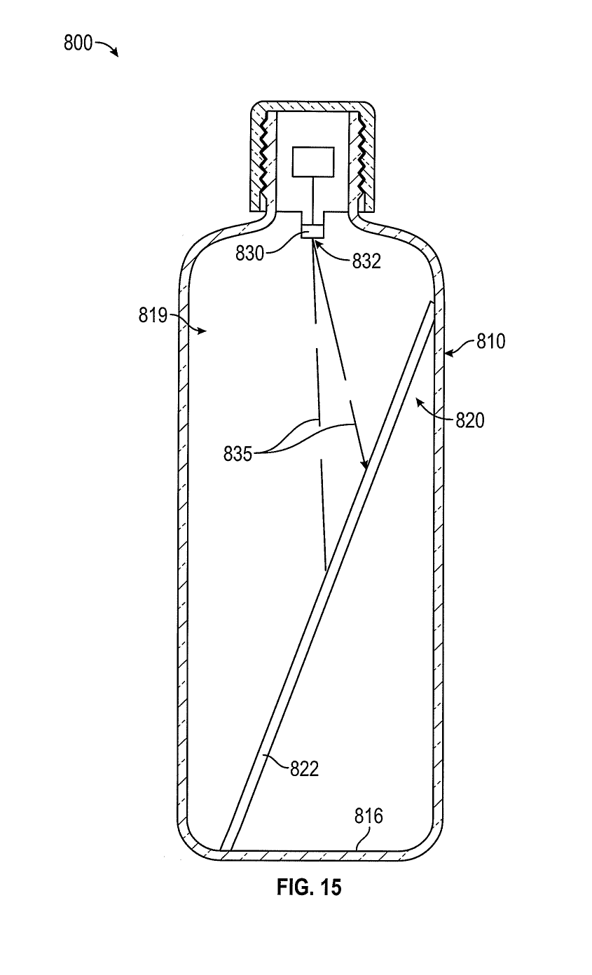

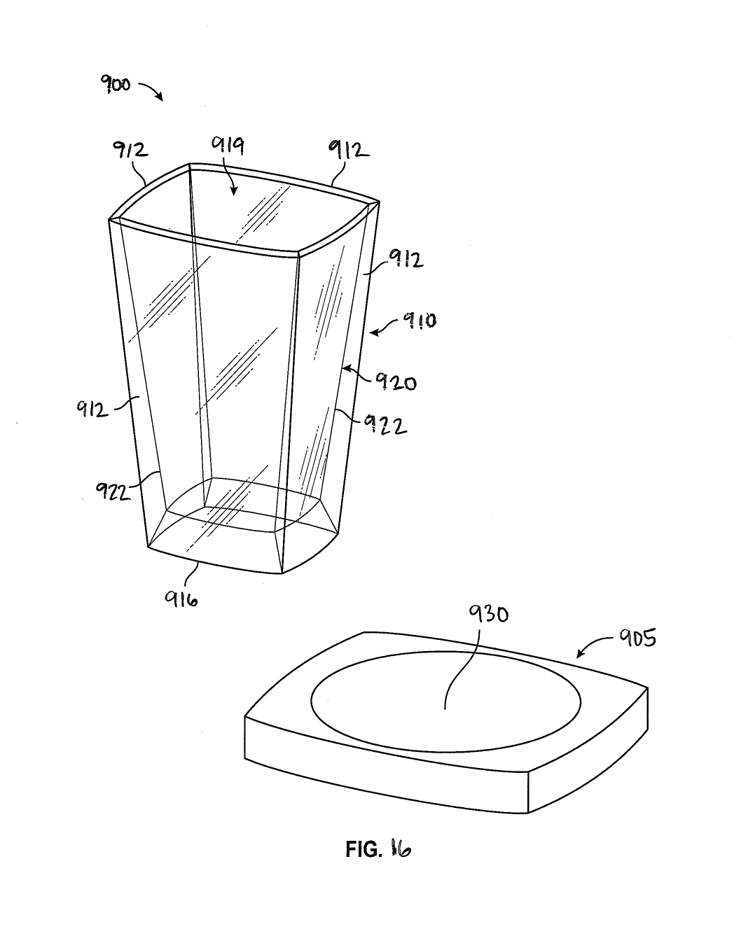

FIG. 15 illustrates another container system 800 that is substantially similar to the embodiment 200, except as specifically noted and/or shown, or as would be inherent. Further, those skilled in the art will appreciate that the embodiment 200 (and thus the embodiment 800) may be modified in various ways, such as through incorporating all or part of any of the various described embodiments, for example. For uniformity and brevity, reference numbers from 800 to 899 may be used to indicate elements corresponding to those discussed above numbered from 200 to 299 (e.g., exterior perimeter 810 corresponds generally to the exterior perimeter 210, floor 816 corresponds generally to the floor 216, watertight cavity 819 corresponds generally to the watertight cavity 219, transparent display 820 corresponds generally to the transparent display 220, projector 830 correspond generally to the projector 230, et cetera), though with any noted, shown, or inherent deviations.

In embodiment 800, the primary differences from the embodiment 200 involve the display 820, the omission of mirror 238, and the projector 830. More specifically, the display 820 has a single panel 822 non-perpendicularly angled from the floor 816, and the projector 830 may suffice with only one image origination area 832. Images are transmitted to the display 820 from the image origination area 832 via image travel path 835. While the viewing experience in the embodiment 800 is not three-dimensional (or “holographic”), contrary to other embodiments described herein, it may nevertheless be sufficient for certain applications. And the image may be viewed from opposite sides of the panel 822 (though not perpendicularly thereto). While the panel 822 (and all other panels described herein) may be fully transparent, a translucent or semi-translucent coating on (or composition of) any of the panels may provide better visibility—and particularly in well-lit environments.

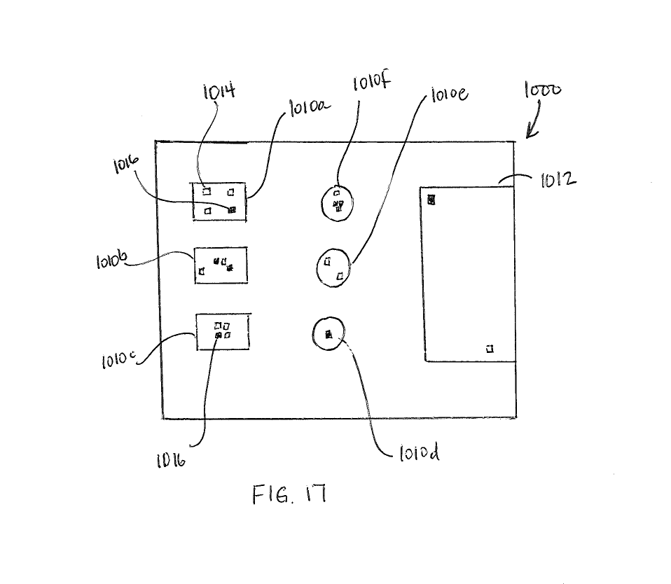

FIG. 16 illustrates still another container system 900. Here, in addition to, or instead of, providing an image via a display, the container may be configured with resonant monitoring capabilities to provide one or more users with information concerning the contents of the container. Resonant excitation may be encouraged from an external stimulus or occur naturally based on environmental ambient conditions (e.g. vibrations on a table top, sound through the air, thermal convection, etc.). In embodiment 900, the container system 900 is similar in structure to embodiment 700 (although the container system 900 may have any configuration), having an exterior perimeter 910, external walls 912, and a floor 916 defining a drinking glass having a cavity 919. A resonant structure 920 comprising one or more panels 922 may be provided within the inside of the glass, and is non-perpendicularly angled from horizontal, and an external excitation device 930. The resonant structure 920 may be a reflective surface. The external excitation device 930 may be, for example, part of a coaster 905 upon which the container system 900 sits. Alternately, the excitation device 930 may be embedded in surfaces upon which the container sits (e.g., a table). In still other alternatives, the excitation device 930 may be completely separate from the container system 900. The external excitation device 930 is configured to provide excitation to the resonant structure 920.

The excitation may be, for example, a laser beam, vibrational, or acoustic energy, or any other appropriate excitation (e.g. modulated or complex waveforms to observe and sense interference patterns). The external excitation device 930 directs the excitation towards the resonant structure 920. The excitation may cause the resonant structure 920 to resonate or provide a reflection, as the case may be. A sensor 950 (which may be incorporated into the resonant structure 920, the container system 900, or completely separate from the container system 900) may detect and analyze the amplitude, frequency, harmonics, spectral energy, and/or wave shape of the resonant response or the reflection from the resonant structure 920. This information may be useful to provide information about the container itself, or the contents of the container. A typical resonant response may be predetermined for each type of container and/or based on different contents. For example, the response may fall within a certain predefined range if the container system 900 is “healthy” (e.g., no cracks). If the response is outside the range, a user may be notified of the discrepancy such that appropriate action can be taken, such as removing the container from service. Or, when the container is full, a typical response would be expected in response to an excitation. If the container is empty, however, the response to the excitation would be atypical. Accordingly, a single excitation may be able to provide a user with current information about the container, and may do so remotely such that the user does not need to be able to see the container or the contents within the container. This may be particularly useful when the container is opaque and the contents cannot be seen.

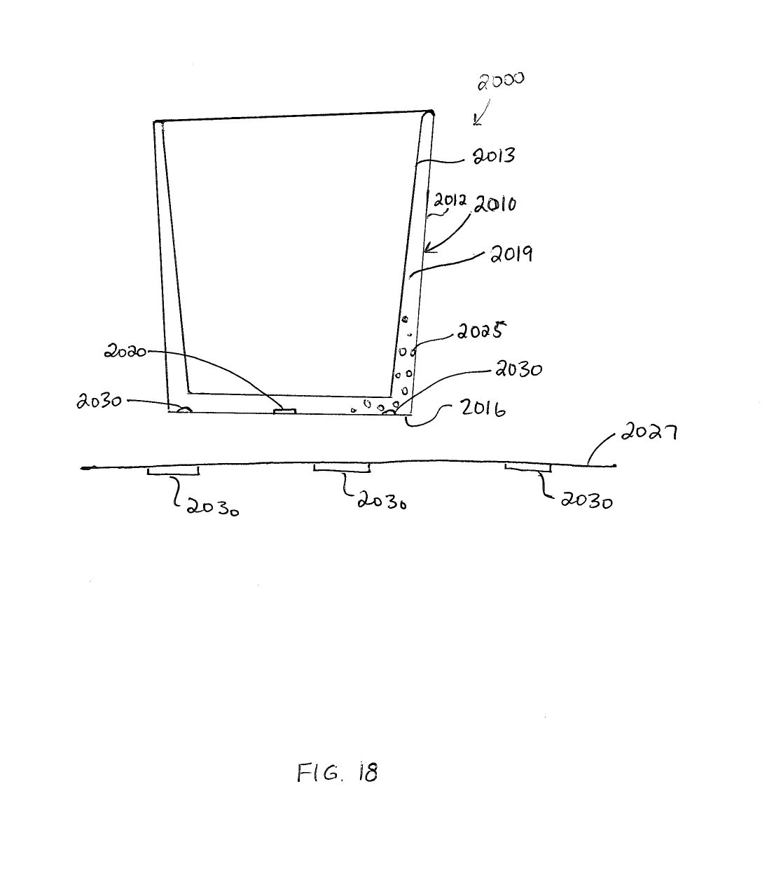

The sensor 950 may be in communication (e.g., wired, wireless, RF, inductive, capacitive, optical, IR, VLC) with a remote device for monitoring the information from the sensor 950. The remote device may be a personal device (e.g., a smart phone or tablet) or it may be a device located at an establishment (e.g., a computer at a restaurant). FIG. 17 illustrates a graphical user interface (GUI) 1000 on a computer in a restaurant. There are six tables 1010a-1010f and a stage 1012. On each table 1010, and on the stage 1012, there is at least one container 1014, represented by a square. The container 1014 may be the container 900, or any other container having a resonant surface 920 in accordance with the teachings herein.

The containers 1014 are therefore configured to receive an excitation from an external excitation device (e.g., device 930) to provide information about the containers 1014 and/or the contents of the container 1014. In the embodiment shown in FIG. 17, the containers 1014 are in use by a patron. The excitation device 930 send out excitation signals at various preprogrammed intervals (e.g., 10 seconds, 30 seconds, 1 minute, etc.). If the sensors 950 detect a response that is atypical (e.g., atypical for a “full” container 1014), the sensor 950 may send a signal to the computer to alert restaurant employees that the container 1014 is empty. In FIG. 17, the containers 1014 are “colored” to indicate an atypical reading. In embodiments, the alert may be an “X” or any other indicator. In further embodiments, multiple indications (e.g., yellow, red) may be used to provide more sophisticated alerts (e.g., yellow indicates a container 1014 that is low but not empty and red indicates a container 1014 that is empty and in need of refill). While this example is directed to an amount of contents in a container 1014, in another example, the health of the container 1014 is monitored. In an embodiment, an excitation signal may be directed to storage areas for containers, such as a cabinet or rack. The health of the containers 1014 (e.g., cracks) can be quickly and easily verified. In order that a user may be able to easily identify the container 1014 of interest, the sensor 950 may provide location information about the container 1014. Optionally, the sensor 950 may include a visual indicator (e.g., a light) to alert a user to the container 1014.

In some embodiments, the container system 900 may be devoid of an angled resonant surface 920. Here, the resonant surface 920 may be configured as part of the container itself (e.g., the rim of a glass), or it may be a tool which may be clipped or otherwise attached to the container (e.g., at the side of the container). In one embodiment, the resonant surface 920 is similar to a drink koozie or a sticker. In another embodiment, the resonant surface 920 is a clip-on base. In still another embodiment, a separate resonant surface 920 may be or placed into the container (e.g., an appropriately configured stirring stick in a glass) or a device resembling an ice cube (which may double as a cooling mechanism). The excitation may be configured to interact with the resonant surface 920 to provide a detectable response.

The display may provide additional functionality as well. For example, in an embodiment, the resonant surface 920 may be configured as a graphically-encoded icon (GEI), such as that described in U.S. patent application Ser. No. 16/198,522, The GEI may be human and/or machine readable to provide a user with certain information about the container or the contents of the container. Optionally, the GEI may be programmable with certain information about the contents, such as the expiration date). The GEI may be excited via the external excitation device 930 in order to provide a resonant response which the user may use to deduce additional information in real-time about the container and/or the contents of the container as described herein.

In embodiments, the GEI and/or other resonant surface 920 is in communication with a smart device, whether now known or later developed. When the resonant surface 920 indicates that the contents of container (e.g., container 900) is low, the smart device may provide an alert. Consider, for example, a refrigerator. Many containers inside the refrigerator have contents that cannot readily be seen (e.g., ketchup container, milk carton, etc.). A user often does not realize that additional goods are needed until it is too late. Here, the containers may be equipped with a resonant surface (e.g., resonant surface 920) as described herein. An excitation device (e.g., excitation device 930) may be provided separately within, or as part of, the refrigerator. At predetermined intervals, the excitation device 930 sends out an excitation signal, and sensor (e.g., sensor 950) records the response. If there are containers with low content levels, expired unsafe contents, etc., a report of the responses may be sent to a user (e.g., to the user's smart phone), and the user can elect to purchase the goods. In embodiments, a user may program the sensor 950 to automatically order the goods via the user's smart device account (e.g., Amazon Prime).

The container system 900 may therefore be configured as a resonant monitoring device for monitoring information related to a container and/or the contents of a container. It shall be understood by those of skill in the art that the contents of the container can be liquid, gel, and/or solid, and that the container system may be any size. In one embodiment, the container is a lotion bottle. In another embodiment, the container is a tank (e.g., for transportation of bulk solids or liquids). In still another embodiment, the container is a spice jar.

Moving on, FIG. 18 illustrates a system for mitigating breakage of containers. Here, a container 2000 has an exterior perimeter 2010, external walls 2012, internal walls 2013, and a floor 2016 defining a cavity 2019. Further, the container 2000 is equipped with a motion sensor 2020 for detecting movement of the container 2000. While the cavity 2019 (and sensor 2020) are shown as being integrated into the container 2000, in embodiments, the cavity 2019 (and/or the sensor 2020) are separate from the container 2000.

Regardless, a responsive material 2025 (e.g., iron shavings) are dispersed within the cavity 2019. When not in use, the responsive material 2025 may simply appear as a reflective surface (and may, in embodiments, be a reflective surface 920). However, the responsive material 2025 may be further configured to react to sudden movement of the container 2000 by travelling in response to the movement of the container 2000 to prevent the container 2000 from tipping and spilling contents or breaking.

To effectuate movement of the responsive material 2025, the sensor 2020 determines an imminent tipping of the container 2000. The sensor 2020 may send an alert (e.g., wirelessly) to actuate one or more electromagnets, thereby causing the responsive material 2025 to move toward the electromagnet (e.g. iron, steel, ferrofluid, etc.). The electromagnets may be dispersed along the perimeter of the internal walls 2012 and/or internal walls 2013. Alternately, the electromagnets may be separate from the container 2000 and may be, for example, disposed along a surface 2027 (e.g., a countertop surface).

The swift movement of the responsive material 2025 toward the actuated electromagnet(s) 2030 counteracts the tipping forces and allows the container 2000 to remain upright. The sensor 2020 may be programmed to recognize the difference between an intentional tipping (e.g., taking a drink or intentionally pouring contents out of a container) and an unintentional tipping (e.g., due to a user's clumsy mistake).

It shall be understood that the containers 1000, 2000 may incorporate any of the display capabilities described herein, for example with reference to FIGS. 1-15.

Many different arrangements of the various components depicted, as well as components not shown, are possible without departing from the spirit and scope of the present invention. Embodiments of the present invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the present invention. It will be understood that certain features and subcombinations are of utility and may be employed without reference to other features and subcombinations and are contemplated within the scope of the claims. The specific configurations and contours set forth in the accompanying drawings are illustrative and not limiting. Some steps may be performed in different orders than described herein.

1. A container system, comprising:
a first container for holding first contents;
a resonant surface disposed on or within the container; and
an excitation device for providing an excitation to the resonant surface;
wherein the excitation of the resonant surface provides a resonant response, and wherein the resonant response defines information about a property of the container.

2. The container system of claim 1, wherein the resonant surface is a panel disposed within the glass, and is non-perpendicularly angled from horizontal.

3. The container system of claim 1, wherein the excitation device is external to the container.

4. The container system of claim 3, wherein the excitation device is a laser projector.

5. The container system of claim 4, further comprising a base upon which the container sits, wherein the laser is embodied in the base.

6. The container system of claim 1, further comprising a sensor for detecting the resonant response of the resonant surface.

7. The container system of claim 6, wherein the sensor activates an alert based on the resonant response.

8. The container system of claim 7, wherein the alert is a visual indicator.

9. The container system of claim 7, wherein the property of the container is a health attribute of the container, and wherein the alert is activated if the resonant response is outside of a predetermined threshold, the predetermined threshold being based on a resonant response of a healthy container.

10. The container system of claim 6, wherein the property of the container is the volume of the contents in the container, and wherein the sensor activates the alert if the volume of the container is below a predetermined threshold.

11. The computing system of claim 10, wherein the alert is instructions to place an order for a second container for holding second contents, and wherein the first contents and the second contents are substantially the same.

12. A container system, comprising:
a container for holding contents;
a reflective surface disposed on or within the container; and
an excitation device for providing an excitation to the reflective surface;
wherein the excitation of the reflective surface provides a resonant response, the response defining information about the properties of the container and the contents therein.

13. The container system of claim 12, wherein the reflective surface is configured as a graphically encoded icon, and wherein the graphically encoded icon is adjacent a surface of the container.

14. The container system of claim 12, wherein the excitation device is external to the container.

15. The container system of claim 12, wherein the reflective surface is a rim of the container.

16. A container system, comprising:
a container for holding contents, the container having a resonant surface disposed on or within the container;
a computing system comprising an excitation device for providing an excitation to the resonant surface and a sensor for measuring a resonant response of the resonant surface in response to the excitation, the resonant response defining an attribute of the container, the computing system further comprising a processor in data communication with a networking device, at least one input/output device, and computer memory, the computer memory comprising a program having machine readable instructions that, when effected by the processor, performs the following steps:
(a) generating an excitation via the excitation device;
(b) determining, via the sensor, a baseline resonant response of the resonant surface;
(c) storing the baseline resonant response in computer memory;
(d) generating a second excitation via the excitation device;
(e) determining, via the sensor, a second resonant response of the resonant surface;
(f) comparing the second resonant response with the baseline resonant response; and
(g) activating an alert if the second resonant response is outside of a predetermined threshold, the predetermined threshold being based on the baseline resonant response.

17. The container system of claim 16, wherein the attribute is a health attribute of the container.

18. The container system of claim 16, wherein the machine readable instructions further perform the following step:
(h) repeating steps (d)-(g).

19. The container system of claim 18, wherein the attribute is a volume of the contents in the container, and wherein the alert is activated if the volume of the contents in the container is below the predetermined threshold for volume of contents in the container.

20. The container system of claim 19, wherein the alert is instructions to place an order for a second container for holding second contents.
